(19) United States
(12) Patent Application Publication
(10) Pub. No.: US 2025/0150131 A1
(43) Pub. Date: May 8, 2025

(54) COMMUNICATION DEVICE FOR BEAMFORMING IN COMMUNICATION SYSTEMS

(71) Applicant: HUAWEI TECHNOLOGIES CO., LTD., Shenzhen (CN)

(72) Inventors: Peng Wang, Kista (SE); Majid Nasiri Khormuji, Kista (SE); Branislav M. Popovic, Kista (SE)

(73) Assignee: HUAWEI TECHNOLOGIES CO., LTD., Shenzhen (CN)

(21) Appl. No.: 19/017,925

(22) Filed: Jan. 13, 2025

Related U.S. Application Data
(63) Continuation of application No. PCT/EP2022/069654, filed on Jul. 13, 2022.

(51) Int. Cl. H04B 7/06

(52) U.S. Cl. CPC H04B 7/0617; H04B 7/063; H04B 7/0634

(57) ABSTRACT

A communication device may be used in a communication system. The communication device includes a set of antenna elements arranged in an antenna aperture. The communication device determines a transformation matrix T based on a coupling matrix C, which includes coupling coefficients between each antenna element in the set of antenna elements. By multiplying the transformation matrix T with a first beamforming matrix f₁ a second beamforming matrix f₂ is obtained. Based on the second beamforming matrix f₂ the communication device transmits a communication signal x via the set of antenna elements in a wireless channel.

### CROSS-REFERENCE TO RELATED APPLICATIONS

This application is a continuation of International Application No. PCT/EP2022/069654, filed on Jul. 13, 2022, the disclosure of which is hereby incorporated by reference in its entirety.

### FIELD

Embodiments of invention relates to a communication device for beamforming in a communication system. Furthermore, the invention also relates to corresponding methods and a computer program.

### BACKGROUND

The massive MIMO (multiple input, multiple output) technology is one of the key components of 3GPP 5G New Radio (NR) that lifts up the performance of wireless communication systems compared to earlier generations. Nevertheless, the quest for further enhancement is still ongoing for 6G and beyond to meet high-rate requirements. In this line of technology, holographic radio is considered as the next step of massive MIMO.

Continuous surfaces have been considered to enable holographic radio links. For example, a simple mathematical model for line-of-sight (LoS) holographic radio channels with continuous surfaces is proposed and the power gain over conventional massive MIMO systems in LoS links is reported to be multiple of dBs. One approach to realize close-to-continuous holographic surfaces is to further densify the conventional antenna arrays, i.e., by packing more antenna elements (aka radiating elements) into the given apertures of transmit or receive antenna arrays, which in limit can approximate the continuous surface. Such a densified antenna array has been also referred to as a holographic surface. These holographic surfaces can be made of low-cost transformative wireless planar structure comprised of sub-wavelength metallic or dielectric scattering particles, which is expected to be capable of shaping electromagnetic waves according to desired objectives and fully explore the potential of the information delivery capability of the wireless medium.

### SUMMARY

The present disclosure provides a solution which mitigates or solves the drawbacks and problems of conventional solutions.

In accordance with one aspect, the present disclosure provides a beamforming solution providing higher gain than conventional solutions.

According to a first aspect, the present disclosure provides a communication device for a communication system, wherein the communication device comprises a set of antenna elements arranged in an antenna aperture, and wherein the communication device is configured to:
determine a transformation matrix T based on a coupling matrix C, wherein the coupling matrix C comprises coupling coefficients between each antenna element in the set of antenna elements;
multiply the transformation matrix T with a first beamforming matrix f₁ to obtain a second beamforming matrix f₂; and
transmit a communication signal x via the set of antenna elements based on the second beamforming matrix f₂.

An advantage of the communication device according to the first aspect is that the obtained second beamforming matrix f₂ can take into account both the spatial relationship between a transmitter and a receiver via the first beamforming matrix f₁, and the mutual coupling effect between the antenna elements in the antenna aperture via the transformation matrix T, such that the achievable beamforming gain of the second beamforming matrix f₂ can be maximized and significantly higher than that of the first beamforming matrix f₁.

In an implementation form of a communication device according to the first aspect, the coupling matrix C is determined based on any in the group comprising: a geometry of the antenna aperture, positions of the antenna elements in the antenna aperture, relative positions of the antenna elements in the antenna aperture, spacings between the antenna elements in the antenna aperture, and a radiation power pattern of each antenna element.

An advantage with this implementation form is that the determined coupling matrix C can fully characterize the mutual coupling effect between the antenna elements in the antenna aperture.

In an implementation form of a communication device according to the first aspect, the coupling matrix C is determined based on the formula:

$${c}_{m , n} = \frac{1}{4 π} {G}_{m}^{1 / 2} ( u ) {G}_{n}^{1 / 2} ( u ) {e}^{j2 π {u}^{T} ( {t}_{m} - {t}_{n} ) / λ} d u , ∀ m , n = 1 , 2 , … , N$$

where m and n are antenna element indices, N is the total number of antenna elements in the set of antenna elements, [symbol] ᵤₙᵢₜ is a set of all points on a sphere centered at the origin with unit radius, Gₙ(u) is a radiation power pattern of the nth antenna element in a direction u, tₙ is a position of the nth antenna element in the antenna aperture, and λ is the wavelength of the communication signal x.

An advantage with this implementation form is that it provides an explicit solution to compute the coupling matrix C such that the mutual coupling effect between the antenna elements in the antenna aperture can be characterized. In the case when the integral function, Gₘ^{1/2}(u)Gₙ^{1/2}(u)e^{j2πu}^{^{T}}^{(t}^{ₘ}^{-t}^{ₙ}^{)/λ}, has explicit closed-form expression, the coupling matrix C may be computed by solving the integral analytically to yield a neat expression. In the general case when the integral function Gₘ^{1/2}(u)Gₙ^{1/2}(u)e^{j2π}^{^{T}}^{(t}^{ₘ}^{-t}^{ₙ}⁾⁸⁰ is not integrable, a numerical integration can be applied to obtain the explicit expression of the coupling matrix C. In both cases, the coupling matrix C only needs to be computed (off-line) once, and then it can be applied for the beamforming design in any communication scenario and channel realization.

In an implementation form of a communication device according to the first aspect, the transformation matrix T is determined based on a second root of the inverse of the coupling matrix C.

An advantage with this implementation form is that by the transformation matrix T determined in this way, the resultant second beamforming matrix f₂ can achieve the maximum beamforming gain of the antenna array.

In an implementation form of a communication device according to the first aspect, the transformation matrix T is determined based on a subset of K eigenvectors vₖ with corresponding eigenvalues λₖof the coupling matrix C having dimension N×N, wherein K<N and N is the total number of antenna elements in the set of antenna elements.

An advantage with this implementation form is that by the transformation matrix T determined in this way, the resultant second beamforming matrix f₂ can avoid the numerical precision problem in the computation of the second root of the inverse of the coupling matrix C. The numerical precision problem occurs when the coupling matrix C is near singular and contains close-to-zero eigenvalues due to the very small spacing between antenna elements in the antenna aperture and/or the very large aperture size of the antenna aperture. Consequently, the second root of the inverse of the close-to-zero eigenvalues can be very sensitive to the numerical precision of these close-to-zero eigenvalues, i.e., a very small precision error in the computation of the coupling matrix C will lead to a very large difference in the resultant values of the second root of the inverse of the coupling matrix C.

In an implementation form of a communication device according to the first aspect, the transformation matrix T is determined based on the formula:

$$T = α ( \begin{matrix}{v}_{1} & {v}_{2} & … & {v}_{k}\end{matrix} ) ( \begin{matrix}\overline{{λ}_{1}} & 0 & … & 0 \\ 0 & \overline{{λ}_{2}} & … & 0 \\ ⋮ & ⋮ & ⋱ & ⋮ \\ 0 & 0 & … & \overline{{λ}_{K}}\end{matrix} ) {( \begin{matrix}{v}_{1} & {v}_{2} & … & {v}_{k}\end{matrix} )}^{H}$$

where α is a scaling factor and λ̅ₖ̅=λₖ^{-1/2}.

An advantage with this implementation form is that by the transformation matrix T determined in this way, the resultant second beamforming matrix f₂ can capture and utilize most of the mutual coupling effect between antenna elements in the antenna aperture and achieves a significantly larger beamforming gain than that achieved by the first beamforming matrix f₁, and a proper value of the scaling factor α can be selected to fulfill the power constraint at the transmitter.

In an implementation form of a communication device according to the first aspect, the subset of K eigenvectors vₖ comprises all the eigenvectors of the coupling matrix C whose corresponding eigenvalues λₖ is equal to or larger than a threshold Γ.

An advantage with this implementation form is that by properly setting the value of the threshold Γ according to the numerical precision of the software used to compute the second root of the inverse of the coupling matrix C, the obtained second beamforming matrix f₂ via the transformation matrix T determined in this way can achieve a good tradeoff between the avoidance of the numerical precision problem and the achievable beamforming gain.

In an implementation form of a communication device according to the first aspect, the spacings between the antenna elements in the antenna aperture is less than half the wavelength λ of the communication signal x.

An advantage with this implementation form is that when the spacings between the antennas is less than half the wavelength of the communication signal x, the mutual coupling between the antenna elements will come into effect, which can be utilized to achieve a higher beamforming gain.

In an implementation form of a communication device according to the first aspect, the communication device is configured to:
transmit the communication signal x via the set of antenna elements based on the second beamforming matrix f₂ and a scaling factor α in dependence on a power constraint.

An advantage with this implementation form is that by transmitting the communication signal x using the second beamforming matrix f₂, the achievable beamforming gain, and in turn the received signal power at the receiver can be maximized. In the meanwhile, the scaling factor α can be used to guarantee that the power constraint at the transmitter is fulfilled.

In an implementation form of a communication device according to the first aspect, the first beamforming matrix f₁ is a predetermined beamforming matrix according to a communication standard.

An advantage with this implementation form is that with the first beamforming matrix f₁ predetermined according to a communication standard, the corresponding second beamforming matrix f₂ can generate a beam pattern that points to a predetermined spatial direction that is determined by the first beamforming matrix f₁. When a number of the first beamforming matrices {f₁} are predetermined according to a communication standard, to form a beam codebook, the corresponding set of the second beamforming matrices {f₂} can be used to generate a set of beam patterns, e.g., a new beam codebook, that cover a range of spatial directions of interest, and in the meanwhile achieve higher beamforming gains than those of the predetermined first beamforming matrices {f₁} by taking into account the mutual coupling effect between the antenna elements in the antenna aperture.

In an implementation form of a communication device according to the first aspect, the first beamforming matrix f₁ is a beamforming matrix determined based on any in the group comprising: a target beamforming direction, positions of the antenna elements in the antenna aperture, relative positions of the antenna elements in the antenna aperture, and radiation power pattern of each antenna element in the target beamforming direction.

An advantage with this implementation form is that with the first beamforming matrix f₁ determined based on any in the abovementioned group of information, the corresponding second beamforming matrix f₂ can generate a beam pattern that points to an arbitrary target spatial direction, and this desired spatial direction can be freely changed so as to adapt to spatial direction of the receiver with respect to the transmitter, even if the receiver is keeping moving.

In an implementation form of a communication device according to the first aspect, the communication device is a network access node, such as a base station, or a client device, such as a user equipment.

An advantage with this implementation form is that an array of densely deployed antenna elements can be equipped at both the base station and the user equipment, so as to achieve enhanced beamforming gains at both sides to improve the system performance.

According to a second aspect, the present disclosure provides a method for a communication device comprising a set of antenna elements arranged in an antenna aperture, the method comprising:
determining a transformation matrix T based on a coupling matrix C, wherein the coupling matrix C comprises coupling coefficients between each antenna element in the set of antenna elements;
multiplying the transformation matrix T with a first beamforming matrix f₁ to obtain a second beamforming matrix f₂; and
transmitting a communication signal x via the set of antenna elements based on the second beamforming matrix f₂.

The method according to the second aspect can be extended into implementation forms corresponding to the implementation forms of the communication device according to the first aspect. Hence, an implementation form of the method comprises the feature(s) of the corresponding implementation form of the communication device.

The advantages of the methods according to the second aspect are the same as those for the corresponding implementation forms of the communication device according to the first aspect.

Embodiments of the invention also relates to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

### BRIEF DESCRIPTION OF THE DRAWINGS

The appended drawings are intended to clarify and explain different embodiments of the invention, in which:

FIG. 1 shows a communication device according to embodiments of the disclosure.

FIG. 2 shows a flow chart of a method for a communication device according to embodiments of the disclosure.

FIG. 3 illustrates a set of antenna elements in an antenna aperture according to embodiments of the disclosure.

FIG. 4 illustrates a communication system according to embodiments of the disclosure.

FIG. 5 shows a block diagram of parts of a communication device according to embodiments of the disclosure.

FIG. 6 illustrates a 3D coordinate system for an exemplary holographic radio system according to embodiments of the disclosure.

FIG. 7 shows coupling coefficient between two isotropic/directional antennas m and n with different spacing between them according to embodiments of the disclosure.

FIG. 8 shows the achievable beamforming gain of a square holographic surface with side length L=2λ and different spacings between antenna elements in each row/column of a uniform rectangular antenna array (URA) within the antenna aperture according to embodiments of the disclosure. The disclosed beamforming that takes into account of the mutual coupling effect (solid curves) and the conventional beamforming that does not take into account of the mutual coupling effect (dashed curves) are plotted.

FIG. 9 shows the achievable beamforming gain of the disclosed beamforming method in a square holographic surface with different side lengths and different spacings between antenna elements in each row/column of a URA according to embodiments of the disclosure.

FIG. 10 shows horizontal cuts of the radiation power patterns achieved by (a) the conventional beamforming and (b) the disclosed beamforming method using a square holographic surface of side length L=2λ deployed with an isotropic URA with different spacing according to embodiments of the disclosure. The horizontal angle θ∈[−π,π] is illustrated in FIG. 6.

FIG. 11 shows horizontal cuts of the radiation power patterns achieved by (a) the conventional beamforming and (b) the disclosed beamforming method using a square holographic surface of side length L=2λ deployed with a directional URA with different spacing according to embodiments of the disclosure. The horizontal angle θ∈[−π,π] is illustrated in FIG. 6.

### DETAILED DESCRIPTION

When an antenna array is densified for holistic radio systems, more antenna elements are placed in the same aperture size of the array with smaller spacing among them, which creates mutual interactions among the antenna elements. In some embodiments, when a transmit signal vector x=(x₁ x₂ . . . x_{N})^{T} is fed to an N-element antenna array of a transmit holographic surface from a transmit circuit, the corresponding current fed to each transmit antenna element with index n=1, 2, . . . , N, i.e., xₙ, generates an electromagnetic field, which when propagating to each of the other transmit antenna element, e.g., antenna n′, induces a current on it, denoted by i_{n→n′}⁽⁰⁾. Afterwards, the superposition of the currents induced on each transmit antenna, e.g. antenna n′, by the currents fed to the other antennas {xₙ|n≠n′}, denoted by i_{n′}⁽⁰⁾=Σ_{n=1,n≠n′}^{N}i_{n→n′}⁽⁰⁾, also generates a new electromagnetic field that can in turn propagate to each of the other antenna elements, e.g., antenna element n″, and induces a new current on it, denoted by i_{n′=n″}⁽¹⁾. This mutual interaction continues indefinitely until convergence, and eventually the superposition of the actively fed currents x and all induced currents {i_{n→n′}^{(l)}} will form a new signal vector that emits from the transmit holographic surface and propagates into a wireless radio channel. This new signal vector may be referred to as a coupled transmit signal vector and may be denoted by x^{(c)}=(x₁^{(c)} x₂^{(c)} . . . x_{N}^{(c)})^{T} where xₙ^{(c)}=xₙ+Σₗ₌₀^{+∞}Σ_{n′=1,n′≠n}^{N}i_{n′→n}^{(l)}.

In most research efforts on conventional antenna arrays including massive MIMO, the interplay among the antenna elements is not considered, which is justified by the fact that when the antenna element spacing is large enough, e.g., half of the wavelength, such effect is weak and has an ignorable impact in the design and analysis of the communication links. However, when we move toward densified antenna arrays for which the spacing among the antenna elements could be arbitrarily small, the interaction among the antenna elements should be accounted for. Therefore, to not take into account the above electromagnetic interaction among the antenna elements that are placed close to one another within the holographic surface aperture may degrade the beamforming performance.

Therefore, the present disclosure discloses a beamforming solution for communication systems by means of a holographic surface deployed with an arbitrarily dense antenna array. Toward this end, a characterization of the mutual coupling effect for a general holographic surface consisting of densely packed radiating antenna elements with arbitrary deployment and radiation power pattern per antenna element is also disclosed.

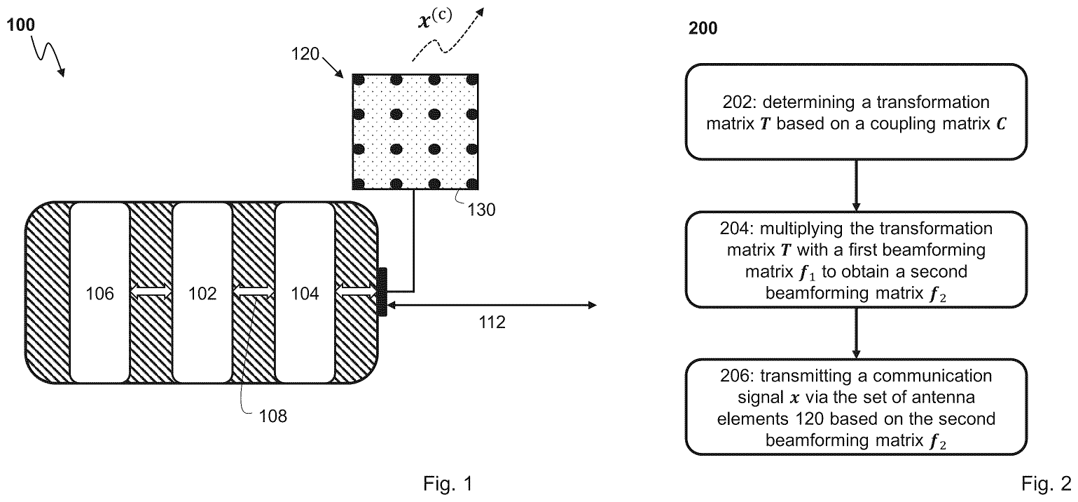

FIG. 1 shows a communication device 100 according to an embodiment of the invention. In the embodiment shown in FIG. 1, the communication device 100 comprises a processor 102, a transceiver 104 and a memory 106. The processor 102 is connected to the transceiver 104 and the memory 106 by communication means 108 known in the art. The communication device 100 may be configured for wireless and/or wired communications in a communication system. The wireless communication capability may be provided with an antenna array connected to the transceiver 104. The antenna array comprises a set of antenna elements 120 arranged in an antenna aperture 130. The wired communication capability may be provided with a wired communication interface 112 e.g., connected to the transceiver 104.

The processor 102 may be referred to as one or more general-purpose CPU, one or more digital signal processor (DSP), one or more application-specific integrated circuit (ASIC), one or more field programmable gate array (FPGA), one or more programmable logic device, one or more discrete gate, one or more transistor logic device, one or more discrete hardware component, or one or more chipsets. The memory 106 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset. That the communication device 100 is configured to perform certain actions can in this disclosure be understood to mean that the communication device 100 comprises suitable means, such as e.g., the processor 102 and the transceiver 104, configured to perform the actions.

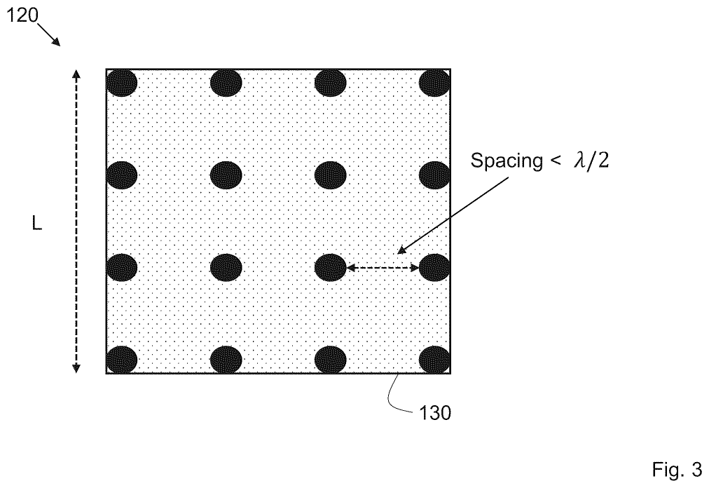

According to embodiments of the invention, the communication device 100 comprises a set of antenna elements 120 arranged in an antenna aperture 130 as illustrated in FIG. 3. Thus, it is herein disclosed a communication device 100 for beamforming using a holographic surface made of deployed antenna elements. The disclosed solution is applicable to an arbitrary deployment of the antenna elements in the antenna aperture and arbitrary radiation power pattern per radiating element in the array. However, in embodiments of the invention, the spacings between the antenna elements in the antenna aperture 130 is less than half the wavelength A of the communication signal x as illustrated in FIG. 3, i.e., a densely deployed antenna aperture.

The communication device 100 is configured to determine a transformation matrix T based on a coupling matrix C, wherein the coupling matrix C comprises coupling coefficients between each antenna element in the set of antenna elements 120. The communication device 100 is further configured to multiply the transformation matrix T with a first beamforming matrix f₁ to obtain a second beamforming matrix f₂. The communication device 100 is further configured to transmit a communication signal x via the set of antenna elements 120 based on the second beamforming matrix f₂.

FIG. 2 shows a flow chart of a corresponding method 200 which may be executed in a communication device 100, such as the one shown in FIG. 1, comprising a set of antenna elements (120) arranged in an antenna aperture 130. The method 200 comprises determining 202 a transformation matrix T based on a coupling matrix C, wherein the coupling matrix C comprises coupling coefficients between each antenna element in the set of antenna elements 120. The method 200 further comprises multiplying 204 the transformation matrix T with a first beamforming matrix f₁ to obtain a second beamforming matrix f₂. The method 200 further comprises transmitting 206 a communication signal x via the set of antenna elements 120 based on the second beamforming matrix f₂. The first beamforming matrix f₁ may also be denoted a first beamforming vector f₁ and the second beamforming matrix f₂ may also be denoted a second beamforming vector f₂ depending on the application.

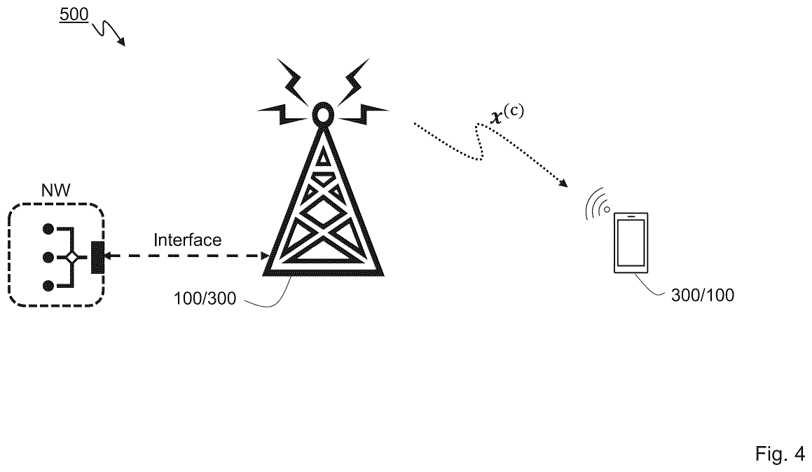

FIG. 4 illustrates a communication system 500 according to embodiments of the invention. The communication system 500 in the disclosed example comprises a communication device 100 and an additional second communication device 300 configured to communicate and operate in the communication system 500. For simplicity, the shown communication system 500 only comprises one communication device 100 and one additional communication device 300. However, the communication system 500 may comprise any number of communication devices 100 and any number of additional communication devices 300 without deviating from the scope of the invention.

The present communication device 100 may in non-limiting examples act or be configured as a network access node thus communicating with the additional communication device 300 acting or being configured as a client device. However, it may be noted that the reverse order is also possible, i.e., that the additional communication device 300 act as a network access node while the present communication devices 100 act as a client device. The communication devices 100 may also be denoted transmitter device or transmitter. Correspondingly, the additional communication device 300 may be denoted receiver device or receiver. Thus, according to embodiments of the invention, the communication device 100 is a network access node, such as a base station, or a client device, such as a user equipment.

In general terms, the second beamforming matrix/vector is configured by being transferred or transformed from a predetermined first beamforming matrix/vector, where the transformation operation can be characterized by a transformation matrix T constructed based on the mutual coupling effect between the antenna elements in the antenna aperture 130. The present disclosure also presents analytical characterization of the transformation matrix T which can be computed based on the geometrical deployment of the antenna elements and the radiation power pattern of each antenna element in the antenna aperture 130.

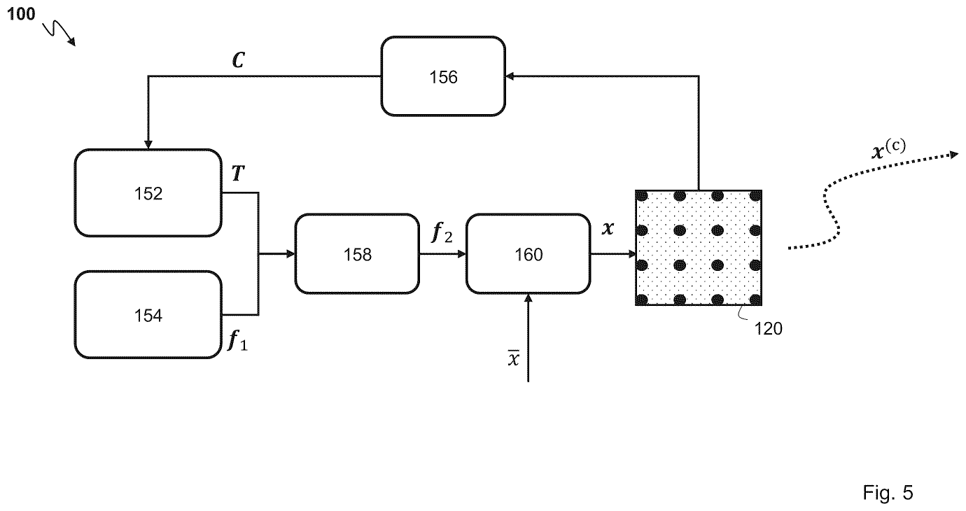

FIG. 5 illustrates a block diagram of the communication device 100 according to embodiments of the invention. A transformation matrix T is determined in the determination block 152 based on a coupling matrix C comprising the coupling coefficients computed in the computation block 156. The computation of the coupling matrix C may be based on the positions and radiation power patterns of the antenna elements in the set of antenna elements 120. By the knowledge of the coupling coefficients thereof, a first beamforming vector f₁ obtained in the obtaining block 154 goes through the transformation matrix T by multiplication in multiplication block 158 to generate an optimized second beamforming vector, i.e., f₂=T·f₁. In multiplication block 160, the second beamforming vector f₂ is multiplied with a signal stream x̅ to obtain a communication signal x which is transmitted via the set of antenna elements 120. The signal stream may comprises information that the receiver is interested in, which can be a sequence of binary bits obtained from output of a source coding block, and then encoded with a certain error-correction coding scheme (such as Turbo coding, LDPC coding, and Polar coding) and modulated with a certain modulation scheme (such as BPSK, QPSK, and QAM). The coded and modulated sequence may be further modulated using orthogonal frequency division multiplexing (OFDM) or DFT-spread-OFDM (DFT-s-OFDM). However, also other types of signal processing, that may conform to different communication standards, are applicable.

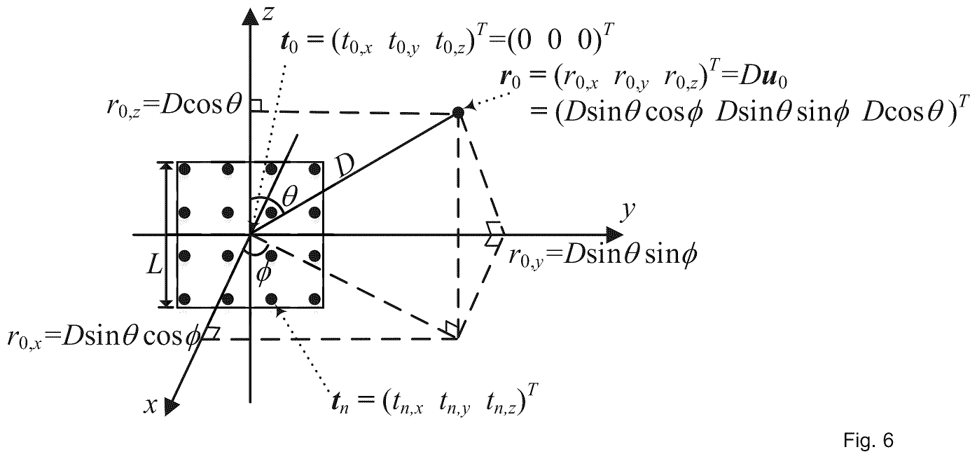

With reference to FIG. 6, the communication device 100 may be equipped with a holographic surface, also herein denoted an antenna aperture 130, which comprises of an antenna array of N antenna elements in a set of antenna elements 120. The antenna elements may be densely placed in the antenna aperture 130. Without loss of generality, a three dimension (3D) coordinate system may be established such that the center of a holographic surface t₀ is located at the origin of the coordinate system, i.e., t₀=(0 0 0)^{T}, and the position of any point in the coordinate system can be represented by a length-3 real vector p=(pₓ p_{y} p_{z}) where pₓ, p_{y} and p_{z} denote the coordinates of point p at the x-axis, y-axis and z-axis, respectively.

As illustrated in FIG. 6, with a square holographic surface corresponding to the antenna aperture 130 with side length L as an example, the position and the radiation power pattern of the n-th (n=1, 2, . . . , N) antenna element are denoted by tₙ and Gₙ(u), respectively, where u∈ [symbol] ᵤₙᵢₜ is an arbitrary steering direction with [symbol] ᵤₙᵢₜ={u′|∥u′∥=1} being a set of all points on a sphere with unit radius centered at the origin, and the radiation power pattern of each antenna element satisfies

$$\frac{1}{4 π} {G}_{n} ( u ) d u = 1 , ∀ n = 1 , 2 , … , N \qquad ( 1 )$$

to ensure the physical principle of energy conservation when each antenna element is deployed alone.

The antenna aperture 130 may be configured to transmit a unit-power signal stream x̅ (i.e., E(|x|²)=1) towards a target spatial direction uₜ. To illustrate the present beamforming solution, a single receive isotropic antenna located at a position r₀=(r_{0,x} r_{0,y} r_{0,z})^{T} in the target steering direction uₜ with horizontal angle ϕ, vertical angle θ and a sufficiently large distance D from the origin, i.e., the center of the antenna aperture 130, is considered hereafter. This yields,

$${r}_{0} = {( {r}_{0 , x} {r}_{0 , y} {r}_{0 , z} )}^{T} = D {u}_{t} where {u}_{t} = {( sin θcosϕ sin θsinϕ cos θ )}^{T} \qquad ( 2 )$$

and the free-space line-of-sight (LoS) channel between the antenna aperture 130 and the receive isotropic antenna can be written as

$$h ( {u}_{t} ) = \frac{λ {e}^{- j 2 π D / λ}}{4 π D} {( {G}_{1}^{\frac{1}{2}} ( {u}_{t} ) {e}^{- \frac{j 2 π {u}_{t}^{T} {t}_{1}}{λ}} {G}_{2}^{\frac{1}{2}} ( {u}_{t} ) {e}^{- \frac{j 2 π {u}_{t}^{T} {t}_{2}}{λ}} … {G}_{N}^{\frac{1}{2}} ( {u}_{t} ) {e}^{- \frac{j 2 π {u}_{t}^{T} {t}_{N}}{λ}} )}^{T} \qquad ( 3 )$$

where λ is the wavelength of the communication signal x.

For a given beamforming vector f used to transmit the signal stream x̅, the transmit signal vector that is fed to the antenna aperture 130 is given by

$$x = f \overline{x} \qquad ( 4 )$$

and the corresponding transmit power can be written as Pₜ=E(∥x∥²)=E(∥fx̅∥²)=∥f∥². If the antenna elements in the antenna aperture 130 are densely deployed, the mutual coupling effect between them alters the communication signal x and results in a different transmit signal, referred to as a coupled transmit signal x^{(c)}, that is observed outside the antenna aperture 130 and propagates into the wireless channel h(uₜ). The received signal at the receive isotropic antenna is therefore

$$y = {h}^{H} ( {u}_{t} ) {x}^{( c )} + z \qquad ( 5 )$$

where z is the additive noise at the receiver device. The relationship between the communication signal vector x and the coupled transmit signal vector x^{(c)} depends on the mutual coupling effect of the antenna elements within the antenna aperture 130. An analytical expression of this relationship for an arbitrary holographic surface is unknown yet.

In conventional solutions, the beamforming vector is designed without taking into account the mutual coupling effect among the antenna elements in the antenna aperture 130, i.e., by assuming that

$${x}^{( c )} \approx x ,$$

the beamforming vector is set to match the wireless channel h(uₜ), i.e.,

$${f}_{prior - art} = \frac{\sqrt{{P}_{t}}}{‖ h ( {u}_{t} ) ‖} h ( {u}_{t} ) \qquad ( 7 )$$

while in the disclosed solution, a linear transformation T is performed on the first beamforming vector f₁ to generate a second beamforming vector f₂ such that it takes into account the mutual coupling effect between the antenna elements, i.e.,

$${f}_{2} = T {f}_{1} . \qquad ( 8 )$$

Thus, the communication device 100 may be configured to transmit the communication signal x via the set of antenna elements 120 based on the second beamforming matrix f₂ according to embodiments of the invention. The achieved beamforming gain is used as a design metric to optimize the beamforming vector. The transformation in Eq. (8) is applied to further improve the achievable beamforming gain at the receiver device.

In embodiments of the invention, the first beamforming matrix f₁ is a predetermined beamforming matrix according to a communication standard. Mentioned standard may e.g., be a 3GPP standard such as 5G and 6G. However, in other embodiments of the invention, the first beamforming matrix f₁ is instead a beamforming matrix determined based on any in the group comprising: a target beamforming direction, positions of the antenna elements in the antenna aperture 130, relative positions of the antenna elements in the antenna aperture 130, and radiation power pattern of each antenna element in the target beamforming direction. For example, based on the positions (relative positions) of the antenna elements and their radiation power patterns in the target beamforming direction, one can first construct the spatial steering vector towards the target beamforming direction. Afterwards, the first beamforming matrix f₁ can be determined to be the conjugate transport of the constructed spatial steering vector with a proper scaling factor to fulfill the power constraint of the transmitter.

Two general embodiments of the invention hereinafter denoted the first embodiment and the second embodiment, respectively, to configure the transformation matrix T are presented in the following disclosure. However, embodiments of the invention are not limited thereto.

In the first embodiment of the invention, the transformation matrix T is found based on the mutual coupling matrix of the antenna aperture 130 to maximize the achievable beamforming gain, where the coupling matrix in turn depends on the positions and radiation power patterns of the antenna elements in the antenna aperture 130. Theorem 1 provides an analytical computation for the coupling matrix for a general antenna aperture 130 containing an array of arbitrarily deployed antenna elements with arbitrary radiation power pattern per antenna element.

In the second embodiment of the invention, the transformation is found based on only a subset of the eigenvalues/eigenvectors of the coupling matrix, which can be determined by employing an additional threshold value. The second embodiment has the advantage of being numerically more stable as the spacing between radiating elements reduces and/or the number of radiating elements in the antenna aperture 130 increases. In some exemplary implementation of the disclosed beamforming solution, a gain of multiple dBs can be achieved by array densification after taking into account the mutual coupling effect compared to the conventional antenna arrays with half-wavelength spacing.

In the first embodiment, an analytical method for computing the coupling matrix C of the antenna aperture 130 comprising an N-element antenna array, denoted by C={c_{m,n}}∈C^{N×N}, is disclosed based on the physical principle of energy conservation. The result is applicable to a general antenna aperture 130 with arbitrary antenna array deployment and arbitrary radiation power pattern per antenna element. With the disclosed coupling matrix C construction method, the relationship between the communication signal vector x and the coupled communication signal vector x^{(c)} is expressed in a closed-form analytical expression. Both this relationship and the elements of the coupling matrix C are detailed in the theorem below. The proof of the theorem is given in the Appendix.

Theorem 1: for an antenna aperture 130 comprising N number of antenna elements, with the position and the radiation power pattern of the n-th, n=1, 2, . . . , N, antenna element being pₙ and Gₙ(u), respectively, the relationship between a communication signal vector x fed to the antenna aperture 130 and the corresponding coupled communication signal vector x^{(c)} that is emitted from the antenna aperture 130 can be expressed as

$${x}^{( c )} = {C}^{- 1 / 2} x$$

where C={c_{m,n}}∈C^{N×N} is the coupling matrix of the antenna aperture 130, whose elements are given by

$${c}_{m , n} = \frac{1}{4 π} \sqrt{{G}_{m} ( u ) {G}_{n} ( u )} {e}^{- j 2 π \frac{{u}^{T} ( {t}_{m} - {t}_{n} )}{λ}} du . \qquad ( 10 )$$

To compute the coupling matrix C using Eq. (10), the positions of the radiating antenna elements (or their relative positions) and radiation power pattern of each antenna element are needed. According to Theorem 1, the transformation matrix T in Eq. (8) can be computed based on

$$T = {T}_{1} = α {C}^{- 1 / 2} . \qquad ( 11 )$$

where α is a scaling factor to fulfill the power constraint of the transmitter. Thus, the transformation matrix T is determined based on a second root of the inverse of the coupling matrix C according to the first embodiment.

The rationale of Eq. (11) can be seen as follows. By substituting Eq. (4) and Eq. (9) into Eq. (5), we can rewrite the received signal at the receive antenna as

$$y = {h}^{H} ( {u}_{t} ) {x}^{( c )} + z = {h}^{H} ( {u}_{t} ) {C}^{- 1 / 2} f \overline{x} + z = {\tilde{h}}^{H} ( {u}_{t} ) f \overline{x} + z \qquad ( 12 )$$

where \tilde{h}^{H}(uₜ)=C^{-1/2}h(uₜ) is the coupled channel vector that combines the joint effect of the wireless channel and mutual coupling effect of the antenna aperture 130. According to the maximum radio combining (MRC) principle, the optimal beamforming vector should be designed to match the coupled channel vector \tilde{h}(uₜ), instead of the wireless channel h(uₜ), i.e.,

$$\begin{matrix}{f}_{Opt} = \frac{\sqrt{{P}_{T}}}{‖ \tilde{h} ( {u}_{t} ) ‖} \tilde{h} ( {u}_{t} ) \\ = \frac{‖ h ( {u}_{t} ) ‖}{‖ \tilde{h} ( {u}_{t} ) ‖} {C}^{- \frac{1}{2}} \cdot \frac{\sqrt{{P}_{T}}}{‖ h ( {u}_{t} ) ‖} h ( {u}_{t} ) \\ = \frac{‖ h ( {u}_{t} ) ‖}{‖ \tilde{h} ( {u}_{t} ) ‖} {C}^{- \frac{1}{2}} \cdot {f}_{prior - art} \\ = {T}_{1} {f}_{prior - art}\end{matrix} \qquad ( 13 )$$

which is consistent with Eq. (8) when Eq. (11) holds and

$$α = \frac{‖ h ( {u}_{t} ) ‖}{‖ \tilde{h} ( {u}_{t} ) ‖} .$$

An advantage of the first embodiment is that the transformation matrix T₁ in Eq. (11) fully takes into account the mutual coupling effect of the antenna aperture 130 and by this means, the resultant received signal power is maximized which implies an optimal solution.

In the second embodiment, the coupling matrix C and the relationship between the communication signal vector x and the coupled communication signal vector x^{(c)} are characterized in the same way as in Theorem 1, and the transformation matrix T in Eq. (8) is determined based on the formula:

$$T = {T}_{2} = α ( \begin{matrix}{v}_{1} & {v}_{2} & … & {v}_{K}\end{matrix} ) ( \begin{matrix}\overline{{λ}_{1}} & 0 & … & 0 \\ 0 & \overline{{λ}_{2}} & … & 0 \\ ⋮ & ⋮ & ⋱ & ⋮ \\ 0 & 0 & … & \overline{{λ}_{K}}\end{matrix} ) {( \begin{matrix}{v}_{1} & {v}_{2} & … & {v}_{K}\end{matrix} )}^{H} \qquad ( 14 )$$

where α is a scaling factor to fulfill the power constraint of the transmitter, λ̅ₖ̅=λₖ^{-1/2}, λₖ and vₖ are, respectively, the k-th largest eigenvalue of the coupling matrix C and its corresponding eigenvector, i.e.,

$$C = ( \begin{matrix}{v}_{1} & {v}_{2} & … & {v}_{N}\end{matrix} ) ( \begin{matrix}{λ}_{1} & 0 & … & 0 \\ 0 & {λ}_{2} & ⋱ & ⋮ \\ ⋮ & ⋱ & ⋱ & 0 \\ 0 & … & 0 & {λ}_{N}\end{matrix} ) {( \begin{matrix}{v}_{1} & {v}_{2} & … & {v}_{N}\end{matrix} )}^{H} , \qquad ( 15 )$$

wherein K<N and N is the total number of antenna elements in the set of antenna elements 120 according to the second embodiment. Thus, the transformation matrix T is determined based on a subset of K eigenvectors vₖ with corresponding eigenvalues λₖ of the coupling matrix C having dimension N×N.

In an implementation of the second embodiment, a predetermined threshold Γ may be used by the communication device 100 to select the eigenvalues. In an example, the predetermined threshold value Γ is set to be a positive real number according to the numerical precision of the algorithm used to perform the eigenvalue decomposition of the coupling matrix C, and an eigenvalue is involved in the computation of the transformation matrix T₂ if

$${λ}_{k} \geq Γ \qquad ( 16 )$$

with Γ (Γ>0) being a predetermined positive real number. Thus, the subset of K eigenvectors vₖ comprises all eigenvalues λₖ of the coupling matrix C that is equal to or larger than a threshold Γ according to embodiments of the invention.

The second embodiment is advantageous because when the antenna elements in the antenna aperture 130 are densely deployed with very small spacing between them, the coupling matrix C tends to be singular and contains eigenvalues very close to zero. As a consequence, computing the transformation matrix T directly using Eq. (11) becomes numerically unstable due to the inverse operation of the near singular coupling matrix C, and the resultant beamforming design hence becomes sensitive to the accuracy of the numerical computations.

The second embodiment can avoid this numerical difficulty, because the transformation matrix T₂ in Eq. (14) is computed in a way that is independent of the close-to-zero eigenvalues/eigenvectors of the coupling matrix C. This is equivalent to confining the transmit signal vector x, and in turn the second beamforming vector f₂ and the coupled transmit signal vector x^{(c)}, in the space spanned by a subset of eigenvectors of the coupling matrix C, which, together with their eigenvalues, can be accurately computed.

In the following section some numerical results are presented to demonstrate the advantages of the disclosed beamforming solution by taking into account the mutual coupling effect between the antenna elements into the beamforming design. In some embodiments, we consider a square antenna aperture (i.e., an area) of side length L, consisting of a total number of N antenna elements deployed on a uniform grid within the given antenna aperture to form a uniform rectangular antenna array (URA) with N^{1/2} elements per row/column, which corresponds to a spacing of d=L/(N^{1/2}−1) between adjacent rows/columns. The URA in the square holographic surface is assumed to be deployed in the (y,z) plane centered at the origin of the 3D coordinate system, with its rows and columns parallel to the y-axis and z-axis, respectively, as illustrated in FIG. 6. Two radiation power patterns of the antenna elements in the antenna aperture are considered: isotropic and directional. For the latter, all the antenna elements are assumed to have the same radiation power pattern as that defined in the specification Study on Channel Model for Frequencies from 0.5 to 100 GHz (Release 16), document 3GPP TR 38.901 V16.1.0, December 2019, which is detailed in Appendix B, and are placed to point in the same direction as the positive half of x-axis, i.e., the normal direction of the surface. In addition, their maximum directional gain is scaled from 8 dBi to 9.8256 dBi so as to fulfill the principle of energy conversation under the lossless assumption per antenna.

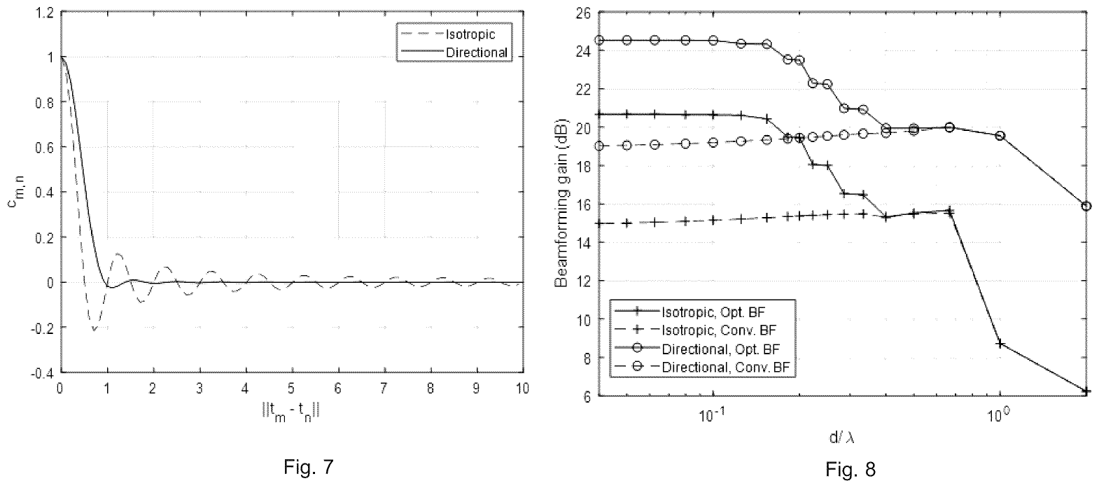

We first check the coupling coefficient c_{m,n} between two antenna elements m and n in the antenna aperture, computed based Theorem 1. FIG. 7 plots the values of c_{m,n} versus the distance between the two antenna elements for the isotropic and directional cases. From FIG. 7 we can observe strong mutual coupling effect when the antenna spacing is small (e.g., less than half-wavelength). When the spacing between the two antenna elements increases, the mutual coupling effect of both isotropic and directional antennas attenuates in an oscillating manner. In some embodiments, the isotropic antennas are uncoupled as long as they are spaced by an integer number of half-wavelength, which is in agreement with the conventional array deployment with half-wavelength spacing such that mutual coupling effect can be ignored. While the directional antennas are still coupled even if they are half-wavelength spaced. The minimum uncoupled spacing is about 0.93λ based on developed methodology, after which the mutual coupling effect vanishes much faster than that of the isotropic antennas.

Then we evaluate the achievable beamforming gain of such a holographic surface compared to the conventional arrays with half wavelength spacing in the same aperture size of the holographic surface. Toward this end, the beamforming gain for the transmit array/holographic surface is defined as the gain of the received signal power over that achieved by transmitting the same signal with the same transmit power using a single isotropic transmit antenna located at the center of the holographic surface. In some embodiments, when the holographic surface is replaced by an isotropic antenna located at its center, both the coupling matrix C and the transfer matrix T simplifies to a unit scalar value, and consequently the equivalent channel vector \tilde{h}(uₜ) reduces to a scalar given by

$${\tilde{h} ( {u}_{t} ) \vert}_{N = 1} = {h}_{i s o} = \frac{λ {e}^{- j 2 π D / λ}}{4 π D} \qquad ( 17 )$$

Hence the beamforming gain achieved by an arbitrary beamforming vector f is defined as

$$g ( f ) = \frac{{‖ {\tilde{h}}^{H} ( {u}_{t} ) f ‖}^{2}}{{\vert {h}_{i s o} \vert}^{2} \cdot {‖ f ‖}^{2}} \qquad ( 18 )$$

As the baseline, we consider the conventional beamforming design in Eq. (7) for comparison. The conventional and disclosed beamforming methods are implemented using MATLAB 2019a, with which we numerically found that the threshold Γ should be no less than 10⁻¹² so as to guarantee stable computation. For other type of practical implementation, depending on the computing capability of the processor the value of threshold Γ can be set accordingly.

FIG. 8 plots the achievable beamforming gains in the normal direction of the holographic surface using the prior-art and disclosed beamforming designs, versus the spacing between adjacent antenna elements in each row/column, where side-length of the square holographic surface is set at L=2λ. It can be seen that by the conventional beamforming that does not take into account the mutual coupling effect between antennas, deploying the antenna elements with a spacing of λ/2 can already approximately achieve the maximum beamforming gain for both isotropic and directional cases, and further densification of the antenna array does not bring additional beamforming gain when the mutual coupling effect between the antenna elements is not included into the beamforming design. However, by using the disclosed beamforming method that takes into account the mutual coupling effect between antennas, the achievable beamforming gain can be further increased with the antenna densification. The effect of densification becomes saturated when d=λ/10, and further array densification only leads to a marginal gain.

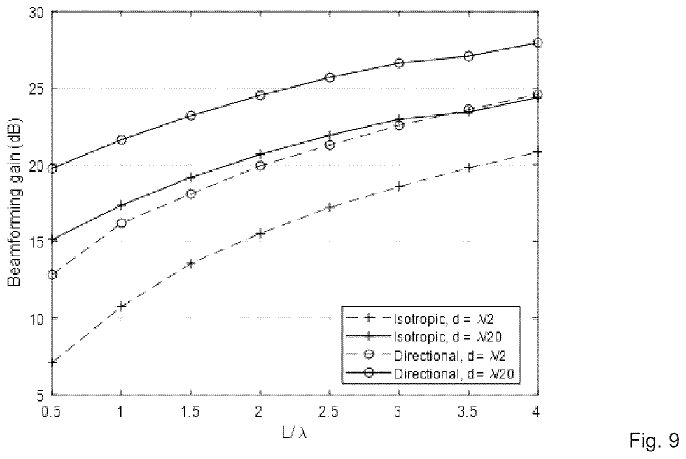

In FIG. 9, we further plot the achievable beamforming gains of the disclosed beamforming method in a square holographic surface with different side lengths and array densities. It can be seen that when the array is sufficiently dense, i.e., with spacing d=λ/20, the gain of array densification (using the disclosed beamforming method) over that achieved by the conventional half-wavelength spaced array in the same aperture decreases with the increase of the antenna aperture. The gain is about 7.5 dB for both the isotropic and directional cases when the surface aperture is 0.51×0.51, which reduces to less than 4 dB when the antenna aperture is 4λ×4λ.

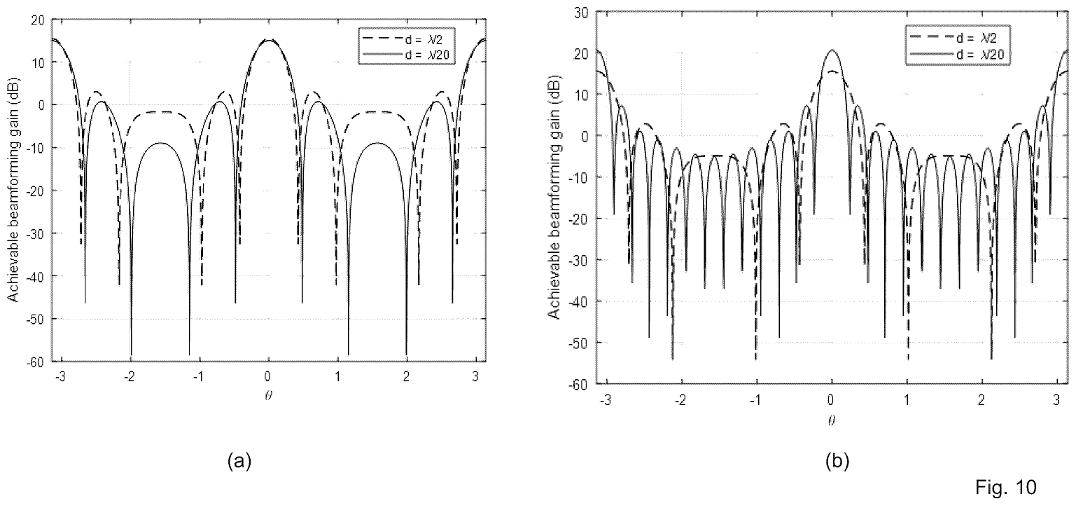

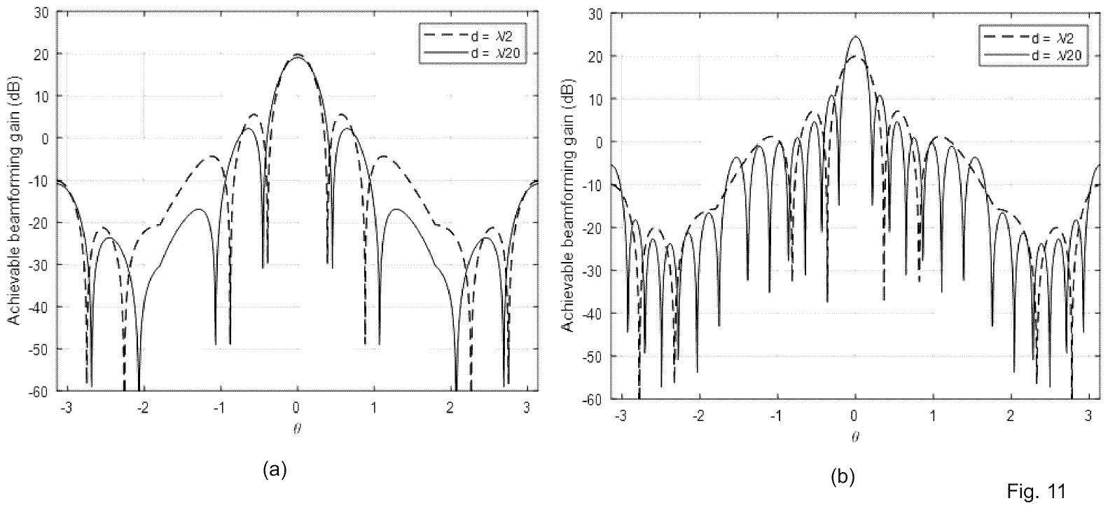

Finally, we evaluate the radiation power patterns of the whole holographic surface with different array densities and beamforming methods. We fix the antenna aperture at L=2λ and select the steering direction to be the normal direction of the holographic surface, i.e., the positive half of the x-axis. In FIGS. 10 and 11, we plot the horizontal cut (in the (x, y) plane) of the radiation power patterns of the holographic surface deployed with an isotropic and directional URA, respectively, with different spacings and beamforming methods. It can be seen that the conventional beamforming does not benefit from the array densification in terms of either beamforming gain and beam width, while the disclosed beamforming method can, after array densification, achieve a narrower beam width besides a higher beamforming gain that has been demonstrated in FIG. 8, which implies that a potentially higher number of degrees of freedom can be supported by a holographic surface compared to a conventionally uncoupled antenna array within the same aperture size, thanks to the efficient utilization of the mutual coupling effect of the antenna elements in the antenna aperture.

### Proof of Theorem 1

According to Eq. (3) and (5), the received signal power at the receive isotropic antenna located in an arbitrary spatial direction u with distance D from the center of a holographic surface can be written as

$${P}_{R} = E {‖ {h}^{H} ( u ) {x}^{( c )} ‖}^{2} = \frac{{λ}^{2}}{16 {π}^{2} {D}^{2}} E ( {\sum }_{m = 1}^{N} {\sum }_{n = 1}^{N} {( {G}_{m}^{\frac{1}{2}} ( u ) {e}^{\frac{j 2 π {u}^{T} {t}_{m}}{λ}} {x}_{m}^{( c )} )}^{*} ( {G}_{n}^{\frac{1}{2}} ( u ) {e}^{\frac{j 2 π {u}^{T} {t}_{n}}{λ}} {x}_{n}^{( c )} ) ) = \frac{{λ}^{2}}{16 {π}^{2} {D}^{2}} E ( {\sum }_{m = 1}^{N} {\sum }_{n = 1}^{N} {( {x}_{n}^{( c )} )}^{*} {G}_{m}^{\frac{1}{2}} ( u ) {G}_{n}^{\frac{1}{2}} ( u ) {e}^{- \frac{j 2 π {u}^{T} ( {t}_{m} - {t}_{n} )}{λ}} ( {x}_{n}^{( c )} ) ) \qquad ( A - 1 )$$

Now, assume a receive sphere center at the origin with a sufficiently large radius D. By recalling that the effective aperture size of an isotropic antenna is Aᵢₛₒ=λ²/4π, we can calculate the received power density on such a receive sphere in an arbitrary spatial direction u to be

$${p}_{R} ( u ) = \frac{{P}_{R}}{{A}_{i s o}} = \frac{1}{4 π {D}^{2}} E ( {\sum }_{m = 1}^{N} {\sum }_{n = 1}^{N} {( {x}_{n}^{( c )} )}^{*} {G}_{m}^{\frac{1}{2}} ( u ) {G}_{n}^{\frac{1}{2}} ( u ) {e}^{- \frac{j 2 π {u}^{T} ( {t}_{m} - {t}_{n} )}{λ}} ( {x}_{n}^{( c )} ) ) \qquad ( A - 2 )$$

Consequently, the total signal power that can be collected by the whole receive sphere is given by

$${P}_{R , sphere} = {\int }_{u ∈ {𝒮}_{u n i t}} {p}_{R} ( u ) {D}^{2} du = E ( {\sum }_{m = 1}^{N} {\sum }_{n = 1}^{N} {( {x}_{n}^{( c )} )}^{*} \cdot \frac{1}{4 π} {\int }_{u ∈ {𝒮}_{u n i t}} {G}_{m}^{\frac{1}{2}} ( u ) {G}_{n}^{\frac{1}{2}} ( u ) {e}^{- \frac{j 2 π {u}^{T} ( {t}_{m} - {t}_{n} )}{λ}} du \cdot ( {x}_{n}^{( c )} ) ) = E ( {\sum }_{m = 1}^{N} {\sum }_{n = 1}^{N} {( {x}_{n}^{( c )} )}^{*} \cdot {c}_{m , n} \cdot ( {x}_{n}^{( c )} ) ) = E ( {( {x}^{( c )} )}^{H} C {x}^{( c )} ) . \qquad ( A - 3 )$$

where C={c_{m,n}}∈C^{N×N} is the coupling matrix of the holographic surface with

$${c}_{m , n} = \frac{1}{4 π} {\int }_{u ∈ {𝒮}_{u n i t}} \sqrt{{G}_{m} ( u ) {G}_{n} ( u )} {e}^{- j 2 π \frac{{u}^{T} ( {t}_{m} - {t}_{n} )}{λ}} du . \qquad ( A - 4 )$$

On the other hand, according to the physical principle of energy conservation, the total signal power collected by the receive sphere should be equal to the total transmit power, i.e., E(x^{H} x). Hence, we have

$${P}_{R , sphere} = E ( {x}^{H} x ) = E ( {( {x}^{( c )} )}^{H} C {x}^{( c )} ) \qquad ( A - 5 )$$

which implies

$$x = {C}^{1 / 2} {x}^{( c )} \qquad ( A - 6 )$$

or equivalently

$${x}^{( c )} = {C}^{- 1 / 2} x . \qquad ( A - 7 )$$

This completes the proof.

### Radiation Power Pattern

In Table 7.3-1 of Study on Channel Model for Frequencies from 0.5 to 100 GHz (Release 16), document 3GPP TR 38.901 V16.1.0, December 2019, a radiation power pattern is defined as repeated in Table I below. In the table, θ_{3 dB}=ϕ_{3 dB}=65° and C=30 dB. Note that the maximum directional gain was set at 8 dBi, which leads to less received power on the whole receive sphere than the power fed to each transmit antenna, due to the heat loss caused by the circuit of the transmit antenna. For simplicity, in this invention we assume that all the antennas are lossless, and thus the maximum directional gain is scaled to 9.8256 dBi to fulfill the principle of energy conservation.

TABLE 1
The radiation power pattern of a directional antenna defined in [13]

| Parameters | Values |
|---|---|
| Vertical cut of the radiation power pattern (dB) | ${A}_{d B} ( θ , ϕ = 0 ) = - min \{ 12 {( \frac{θ - 90 °}{{θ}_{3 d B}} )}^{2} , C \}$ |
| Horizontal cut of the radiation power pattern (dB) | ${A}_{d B} ( θ = 90 ° , ϕ ) = - min \{ 12 {( \frac{ϕ}{{ϕ}_{3 d B}} )}^{2} , C \}$ |
| 3D radiation power pattern (dB) | −min{−(A_{dB}(θ, ϕ = 0) + |
| | A_{dB}(θ = 90°, ϕ)), C} |
| Maximum directional gain | [8 dBi] |

A network access node herein may also be denoted as a radio first communication device, an access first communication device, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio first communication devices may be of different classes or types such as e.g., macro eNodeB, home eNodeB or pico base station, based on transmission power and thereby the cell size. The radio first communication device may further be a station (STA), which is any device that contains an IEEE 802.11-conformant media access control (MAC) and physical layer (PHY) interface to the wireless medium (WM). The radio first communication device may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station (STA), which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a read-only memory (ROM), a programmable read-only memory (PROM), an erasable PROM (EPROM), a flash memory, an electrically erasable PROM (EEPROM), or a hard disk drive.

Moreover, it should be realized that the communication device 100 comprise the communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the communication device 100 may comprise, e.g., one or more instances of a central processing unit (CPU), a processing unit, a processing circuit, a processor, an application specific integrated circuit (ASIC), a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

What is claimed is:

1. A communication device for a communication system, the communication device comprising:
a set of antenna elements arranged in an antenna aperture; and
one or more processors, which alone or in combination is configured to:
determine a transformation matrix T based on a coupling matrix C, wherein the coupling matrix C comprises coupling coefficients between each antenna element in the set of antenna elements;
multiply the transformation matrix T with a first beamforming matrix f₁ to obtain a second beamforming matrix f₂; and
transmit a communication signal x via the set of antenna elements based on the second beamforming matrix f₂.

2. The communication device according to claim 1, wherein the coupling matrix C is determined based on any in a group comprising: a geometry of the antenna aperture, positions of the set of antenna elements in the antenna aperture, relative positions of the set of antenna elements in the antenna aperture, spacings between the set of antenna elements in the antenna aperture, and a radiation power pattern of each antenna element.

3. The communication device according to claim 2, wherein the coupling matrix C is determined based on a formula:
$${c}_{m , n} = \frac{1}{4 π} {G}_{m}^{1 / 2} ( u ) {G}_{n}^{1 / 2} ( u ) {e}^{j 2 π {u}^{T} ( {t}_{m} - {t}_{n} ) / λ} d u , ∀ m , n = 1 , 2 , … , N$$
where n and m are antenna element indices, N is a total number of antenna elements in the set of antenna elements, [symbol] ᵤₙᵢₜ is a set of all points on a sphere centered at the origin with unit radius, Gₙ(u) is a radiation power pattern of an nth antenna element in a direction u, tₙ is a position of the nth antenna element in the antenna aperture, and λ is a wavelength of the communication signal x.

4. The communication device according to claim 1, wherein the transformation matrix T is determined based on a second root of an inverse of the coupling matrix C.

5. The communication device according to claim 1, wherein the transformation matrix T is determined based on a subset of K eigenvectors vₖ with corresponding eigenvalues λₖ of the coupling matrix C having dimension N×N, wherein K<N and N is a total number of antenna elements in the set of antenna elements.

6. The communication device according to claim 5, wherein the transformation matrix T is determined based on a formula:
$$T = ( \begin{matrix}{v}_{1} & {v}_{2} & … & {v}_{K}\end{matrix} ) ( \begin{matrix}\overline{{λ}_{1}} & 0 & … & 0 \\ 0 & \overline{{λ}_{2}} & … & 0 \\ ⋮ & ⋮ & ⋱ & ⋮ \\ 0 & 0 & … & \overline{{λ}_{K}}\end{matrix} ) {( \begin{matrix}{v}_{1} & {v}_{2} & … & {v}_{K}\end{matrix} )}^{H}$$
where λ̅ₖ̅=λₖ^{-1/2}.

7. The communication device according to claim 6, wherein the subset of K eigenvectors vₖ comprises all eigenvectors of the coupling matrix C whose corresponding eigenvalues λₓ are equal to or larger than a threshold Γ.

8. The communication device according to claim 3, wherein the spacings between the set of antenna elements in the antenna aperture is less than half the wavelength λ of the communication signal x.

9. The communication device according to claim 1, wherein the one or more processors of the communication device is configured to:
transmit the communication signal x via the set of antenna elements based on the second beamforming matrix f₂ and a scaling factor α based on a power constraint.

10. The communication device according to claim 1, wherein the first beamforming matrix f₁ is a predetermined beamforming matrix according to a communication standard.

11. The communication device according claim 1, wherein the first beamforming matrix f₁ is a beamforming matrix determined based on any in a group comprising: a target beamforming direction, positions of the antenna elements in the antenna aperture, relative positions of the set of antenna elements in the antenna aperture, and radiation power pattern of each antenna element in the target beamforming direction.

12. The communication device according to claim 1, wherein the communication device is a network access node.

13. A method for operating a communication device, the communication device comprising a set of antenna elements arranged in an antenna aperture, the method comprising:
determining a transformation matrix T based on a coupling matrix C, wherein the coupling matrix C comprises coupling coefficients between each antenna element in the set of antenna elements;
multiplying the transformation matrix T with a first beamforming matrix f₁ to obtain a second beamforming matrix f₂; and
transmitting a communication signal x via the set of antenna elements based on the second beamforming matrix f₂.

14. A non-transitory computer readable storage medium comprising a computer program with a program code for performing the method according to claim 13 when the computer program runs on a computer.

15. The communication device according to claim 12, wherein the network access node is a base station.

16. The communication device according to claim 1, wherein the communication device is a client device.

17. The communication device according to claim 16, wherein the client device is a user equipment.
